(19) United States
(12) Patent Application Publication
(10) Pub. No.: US 2004/0052591 A1
(43) Pub. Date: Mar. 18, 2004

(54) Apparatus for the automatic removal of tubular textiles

(76) Inventor: Gino Bassi, San Giovanni In Persiceto (IT)

Correspondence Address: MCGLEW & TUTTLE, PC, 1 SCARBOROUGH STATION PLAZA, SCARBOROUGH, NY, 10510-0827, US

(21) Appl. No.: 10/601,683

(22) Filed: Jun. 23, 2003

(30) Foreign Application Priority Data
Jul. 4, 2002 (IT) FI2002 A000115

(51) Int. Cl. B65G 51/18

(52) U.S. Cl. 406/191

(57) ABSTRACT

An apparatus for the automatic removal of tubular textiles, particularly for the production of stockings, socks and pantyhose articles; the apparatus comprises a plurality of containers (3), each of which contains a predetermined number of articles (2) all being equally oriented, and is supported by a motor-driven platform (30) to allow moving each container betwee a position of automatic removal of the articles and a different, standby or filling position.

### SPECIFICATION

The present invention refers to an apparatus for the automatic removal of tubular textiles, to be used especially, although not exclusively, in plants for the production of stockings, socks and pantyhose articles.

### BACKGROUND OF THE INVENTION

It is known that the sewing steps relating to the assembly or closing of the toe portions of garments such as stocking, socks and pantyhose articles, include the positioning of blank tubular products (with the toe still to be sewn) at the inlet sections of suitable machines, provided with sewing means, generally known as “line-closer” and “toe-closer” machines. The said positioning must be operated so that the blank tubes result oriented in preset and constant direction. For example, the loading of unfinished products onto the shape of a line-closer must be made so that the respective elastic hem portions (opposite to the toes) will result ahead of the toe portions.

Documents EP 508014 and U.S. Pat. No. 6,386,801 describe apparatuses for the removal of blank products from a container in which they are disposed in bulk and for the subsequent orientation thereof according to a predetermined direction.

These apparatuses result relatively expensive and complex in relation to the current production requirements, especially in relation to productions which suffer from limited investments in machine and equipment.

### SUMMARY OF INVENTION

The main object of the present invention is to overcome the said drawbacks.

This result has been achieved, according to the invention, by adopting the idea of making an apparatus having the characteristics disclosed in the independent claims. Further characteristics being set forth in the dependent claims.

The present invention makes it possible to automatically feel machines for the production of stockings, socks and pantyhose articles by means of an apparatus which is easy to make, cost-effective and reliable even after a prolonged service life.

### BRIEF DESCRIPTION OF THE DRAWINGS

These and other advantages and characteristics of the invention will be best understood by anyone skilled in the art from a reading of the following description in conjunction with the attached drawings given as a practical exemplification of the invention, but not to be considered in a limitative sense, wherein:

FIG. 1 is a schematic perpective view of an apparatus according to the invention;

FIGS. 2A-2D is a plan view of four different types of articles able to be processed by the apparatus of FIG. 1;

FIG. 3 is a schematic front view of the apparatus;

FIG. 4 shows a detail relative to a modified embodiment of the platform for the containers;

FIG. 5 is a schematic diagram of the system for the programmable control of motions;

FIG. 6 is a schematic side view of the apparatus;

FIG. 7 is a schematic side view of the device for the removal of articles;

FIGS. 8A-8D shows schematically the operation of a device for controlling the orientation of the articles.

### DETAILED DESCRIPTION OF THE INVENTION

Reduced to its basic structure, and reference being made to the figures of the attached drawings, an apparatus for the automatic removal of tubular textiles according to the invention, comprises a tube (1) with substantially vertical axis, which is movable in both directions according to its longitudinal axis (double arrow “V”) and is associated with suction means (AS) to allow a vacuum to be operated thereinside.

For the said movement of tube (1) use can be made of a device comprising a carriage (101) associated with a corresponding motor member (100) to which the tube (1) is fixed: the said carriage (101) being mounted for sliding on corresponding straight guides provided inside a supporting metal frame (12) which has a development mostly vertical.

Mounted below the tube (1) is a unit for supplying articles (2), this unit comprising a plurality of containers (3) which are located onto a platform (30) bi-directionally movable (double arrow “O”) orthogonally to the tube (1), so that the movement of the platform (30) will interest in the same manner also the containers (3) supported thereon.

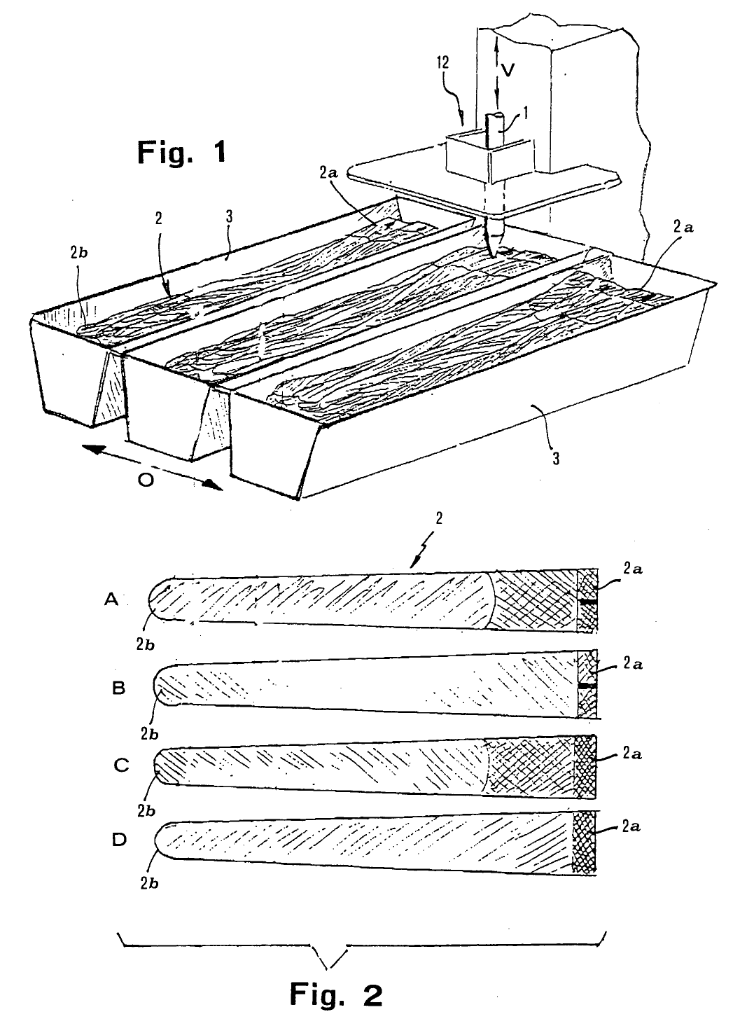

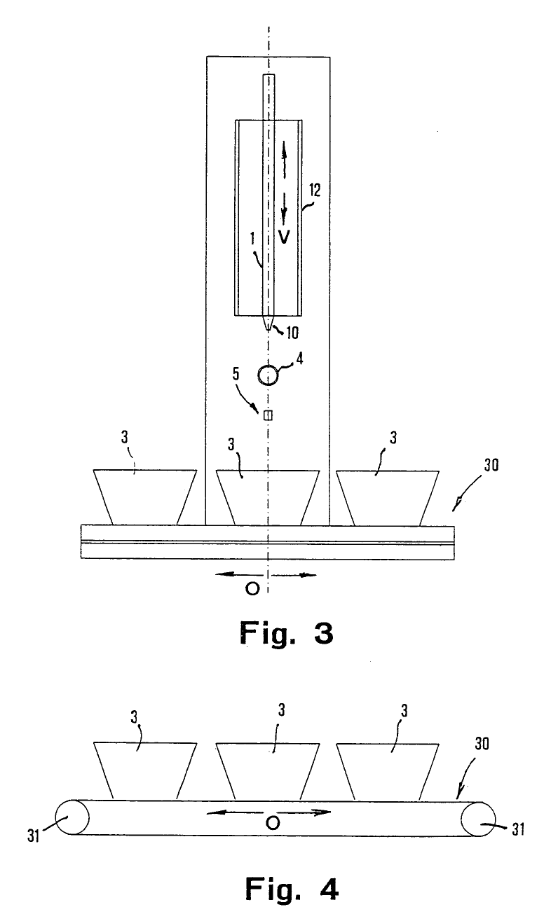

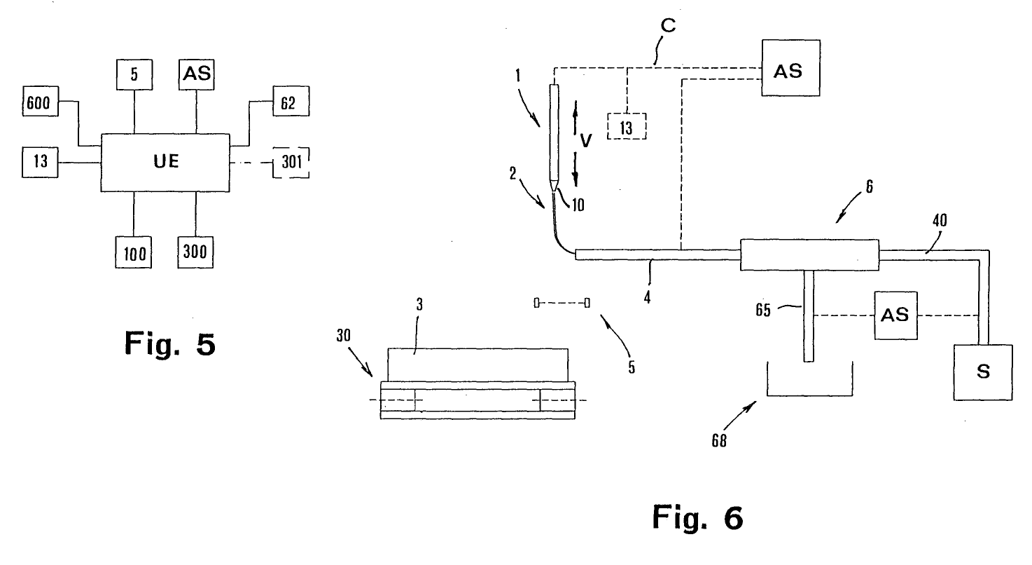

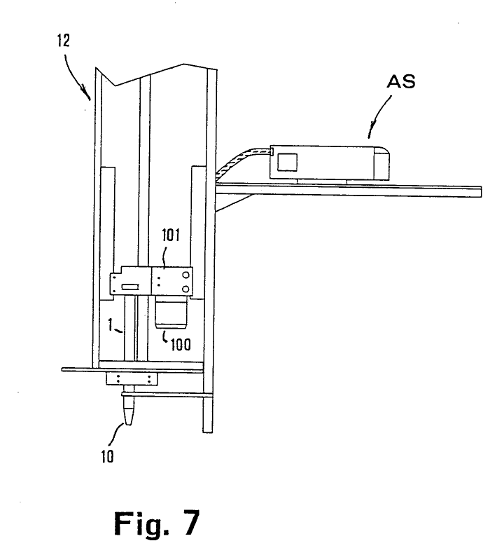

Disposed in overlapping relation, that is, piled up inside each container (3), are a plurality of articles (2) all being equally oriented in a preset direction. For example, in case the articles are tubular textiles to be assembled for making pantyhose articles, that is, tubular textiles with an elastic end of greater thickness (2a) and an opposite, thinner, toe end (2b), they can be located in the containers (3) all oriented with the elastic hem portion (2a) facing the tube (1) as shown in FIG. 1. The positioning of the articles (2) in the containers (3), oriented as above indicated, can be made by hand.

For example, the platform (30) can be made up of a table or plate, with an upper plane for supporting the containers (3), and mounted on guide rails extending transverse to the axis of tube (1), that is, in the direction (V) of the movement of containers (3), the said table or plate being associated with a corresponding electric motor (300) via a belt or chain transmission or through gears (not shown in the drawings).

Alternatively, the platform (30) may consist, as shown schematically in FIG. 4, of the surface of a belt oriented in the said direction (V) and engaged with two pulleys (31) to allow the movement thereof between two limit positions under control of an electric motor (301).

Inserted in the circuit connecting the suction means (AS) with the tube (1) is a vacuometer (13), whose operation will be described later.

The said actuators or electric motors (100, 300, 301), the suction means (AS) and the vacuometer (13) are associated with electronic programmable means (UE) to allow the intervention thereof in a manner to be described below.

The said programmable means (UE) may be of a type known to those skilled in the field of industrial automation and, therefore, will not be described in greater detail.

The operation of the apparatus, as far as the removal of articles (2) is concerned, is as follows.

The central unit (UE) drives the motor (100) to lower the tube (1) until the mouth (10) thereof results disposed in correspondence of the article (2) which is on top within the container of interest, that is, positioned in correspondence of the tube (1). The contact between the mouth (10) of tube (1) and the fabric of the article (2) is detected by the vacuometer (13)—in a much as the said contact corresponds to a pressure change in the circuit (C)—connecting the suction means (AS) with tube (1), and such pressure change is detected by the vacuometer (13) connected with the programmable unit (UE).

At this point, the unit (UE) operates the reversal of rotation direction of motor (100), which causes the tube is (1) to be lifted and the article (2) to be removed from the respective container (3). Upon this step, the article (2) results hanging down while adhering to the mouth (10) of tube (1) on the side of the elastic hem (2a), whereas the toe portion (2b) is free. The lifting travel of the tube (1) is of such an extent as to move the free end (2b) of the article to the level of a stationary conduit (4) also associated with the suction means.

When the free end (2b) of the article (2) passes, during said lifting step, an optical barrier (5) located at a preset distance from the platform (30) and orthogonally oriented to the axis of tube (1), the central unit (UE) deactivates the suction within the tube (1) and activates it within the conduit (4), so that the article (2) results sucked into the latter and moved away along a conduit (40) at the end of which a station (S) may be provided for the treatment of the article. For example, the said station (S) may be one provided with a device for opening the elastic hem (2a), such as described in the U.S. Pat. No. 6,155,466.

When the vacuometer does not detect any pressure change (for example, owing to the fact that the container (3) has been emptied out), then the unit (UE) operates the lowering and subsequent lifting of tube (1) for a preset number of times (for example, two times), therafter, if the vacuometer (13) does not detect pressure changes yet in the pneumatic circuit of tube (1), the unit (UE) activates the motor (300; 301) to drive the platform (30) into translation to the right or to the left (depending on the selections being made in advance when setting the relevant program) by such a travel able to bring another container (3) in correspondence of the tube (1). The containers (3), as they are emptied out, can be filled again while one of them is still in use.

Downstream of said removal device, that is, intermediate between the latter and said station (S), a device (6) can be advantageously provided for controlling and checking the articles.

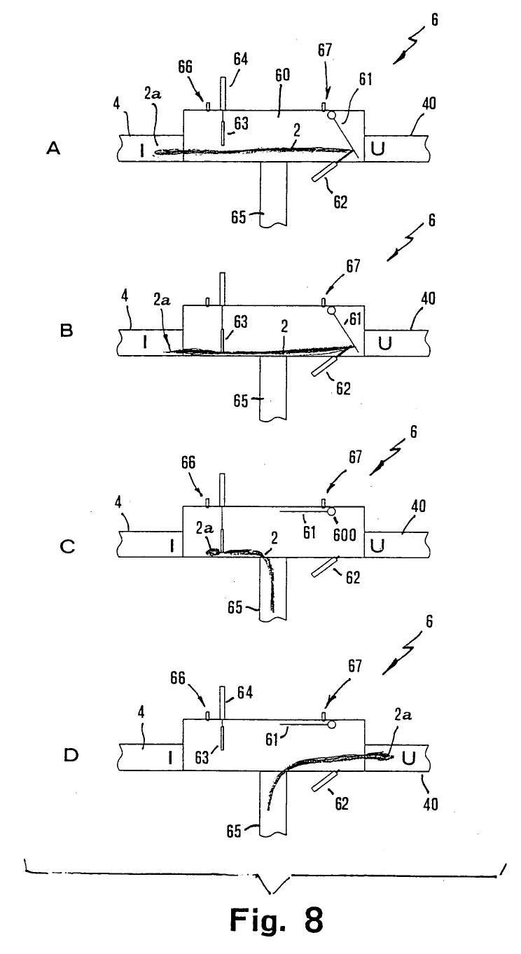

According to the example schematically shown in FIGS. 8A-8D, the control device (6) may be of a type comprising a tubular chamber (60), with a section (I) for the admission of the articles and a section (U) for the exit thereof, with the inlet section (I) being connected with the outlet of tube (1), and with the exit section (U) which discharges on the station (S) through the conduit (40).

Mounted inside said chamber (60) is a gate (61) in proximity of the exit section (U), the gate (61) being rotatively movable under control of a corresponding rotary actuator (600), between a lifted position which uncovers the opening of exit (U) and a lowered position which closes it.

Also provided in proximity of exit section (U) is a small pneumatic piston (62) whose rod is oriented towards the same section (U).

Also mounted inside the chamber (60), but on the section (I) for the admission of articles, is a vertical gate valve (63) associated with a corresponding pnematic actuator (64) whose travel is such that, when the gate (63) is fully lowered, the same gate results in front of the lower base of chamber (60); and between the lower edge of gate (63) and said base of chamber (60) an opening is provided which allows the transit therethrough of the whole article's fabric (included the toe portion) except for the elastic hem (2a). Intermediate between the gates (61) and (63) is a conduit (65) whose mouth is disposed within the tubular chamber (60) for a purpose to be described below.

The operation of the control device above discussed is as follows.

When an article (2) arrives at the chamber (60) through the conduit (4), the gate (61) is lowered, so that the article stops. The transit of the article through the section (I) of chamber (60) and its presence upstream of gate (61) are detected by photocells (66, 67) connected to the central unit (UE).

The enabling command of photocell (67) activates the actuator (62) so that the respective rod blocks the fabric of the article upon the surface of gate (61), as shown in FIG. 8A.

At this point, the suction operated within the chamber (60) is reversed, that is, is directed from section (U) to section (I) of chamber (60). This causes the article to be stretched over the mouth of conduit (65) and below gate (63). The latter is then lowered (as in FIG. 8B), the rod of actuator (62) is retracted, and the suction activated inside the conduit (65).

Accordingly, if the elastic hem, as shown in FIG. 8C and according to the program being set, results upstream of gate (63), as a consequence of how the article has been picked up from the respective container (3), then the gate (63) retains the same article, whose elastic hem has a volume larger than the opening available below the lower edge of gate (63), while the rest of the article enters the conduit (65). This event is detected by photocell (66), then the gate (61) is lifted, the suction is activated in the conduit (40) and deactivated in conduit (65), and the gate (63) is lifted, so that the article transits through the section (U) of chamber (60) with its elastic hem (2a) facing ahead as in FIG. 8D.

If, on the contrary, the article arrives with the elastic portion (2a) turned forwards because, for example, has been located back-to-front inside a container, the article goes completely through the conduit (65) when the suction is activated therein, so that the article is not retained in any point of gate (63) and, through the same conduit, it is unloaded on a point (68) of collection of articles which do not arrive at station (s).

What is claimed is:

1) An apparatus for the automatic removal of tubular textiles, particularly for the production of stockings, socks and pantyhose articles, that comprises a plurality of containers (3), each of which contains a predetermined number of articles (2) all being equally oriented, and that is supported by a motor-driven platform (30) to allow moving each container between a position of automatic removal of the articles and a different, standby or filling position.

2) The apparatus of claim 1, wherein said movable platform (30) consists of a table or plate.

3) The apparatus of claim 1, wherein said movable platform consists in the surface of a ring-closed belt.

4) The apparatus according to one or more preceding claims, wherein it comprises a member (1) for the pneumatic removal of articles (2) and movable from and toward said platform (30).

5) The apparatus according to one or more preceding claims, wherein it comprises a device (6) for controlling the orientation of the articles, the said device (6) being downstream of said removal member (1).
